(19) United States
(12) Patent Application Publication
(10) Pub. No.: US 2013/0209949 A1
(43) Pub. Date: Aug. 15, 2013

(54) TEMPERATURE SENSOR AND HEAT TREATING APPARATUS

(71) Applicants: TOKYO ELECTRON LIMITED, (US); FENWAL CONTROLS OF JAPAN, LTD., (US)

(72) Inventors: TAKANORI SAITO, Oshu-shi (JP); KOJI YOSHII, Oshu-shi (JP); TSUTOMU KURIHARA, Tokyo (JP)

(73) Assignees: FENWAL CONTROLS OF JAPAN, LTD., TOKYO (JP); TOKYO ELECTRON LIMITED, TOKYO (JP)

(21) Appl. No.: 13/751,812

(22) Filed: Jan. 28, 2013

(30) Foreign Application Priority Data
Feb. 10, 2012 (JP) 2012-027628

(51) Int. Cl. G01K 1/14

(52) U.S. Cl. CPC G01K 1/14
USPC 432/36; 374/208

(57) ABSTRACT

A rising characteristic of a temperature is improved, and high-accuracy temperature control is enabled. A temperature sensor according to the present invention includes a temperature detecting element, a heat receiving body to which the temperature detecting element is fixed and that is heated by receiving surrounding heat, a heat receiving body supporting mechanism supporting the heat receiving body at a predetermined position, and a protective tube adjusting the heat receiving body in a predetermined direction and at a predetermined position and holding the heat receiving body therein. In the temperature sensor, the heat receiving body is in a flat plate shape, the temperature detecting element is fixed to the heat receiving body, and the heat receiving body supporting mechanism includes a plurality of connecting narrow tubes connected to one another and a connecting wire passing through the respective connecting narrow tubes to connect and support all the connecting narrow tubes.

### CROSS-REFERENCE TO RELATED APPLICATION

This application claims, under 35 USC 119, priority of Japanese Application No. 2012-027628 filed on Feb. 10, 2012.

### BACKGROUND OF THE INVENTION

The present invention relates to a temperature sensor and a heat treating apparatus in which a method for fixing a temperature detecting element to be attached to an inside of a protective tube has been improved.

In a conventional temperature sensor, a thermocouple as a temperature detecting element is fixed to a heat receiving body, is attached to an inside of a protective tube, and is fixed at a predetermined position as in Patent Document 1 (Japanese Patent Laid-Open No. 2002-296122) and Patent Document 2 (Japanese Patent Laid-Open No. 2001-208616), for example. The heat receiving body itself is not attached to a set position in the protective tube accurately but is attached to an inside of the protective tube together with the thermocouple.

However, in the aforementioned conventional temperature sensor, detection accuracy is improved by providing the heat receiving body, but since the heat receiving body itself is not provided at an accurate position or in an accurate direction, there is a problem in a rising characteristic of a temperature in a case where the temperature is measured with high accuracy.

Thus, when a semiconductor wafer is subjected to a heat treatment by controlling the temperature with high accuracy, a slight difference occurs between a detected temperature by the temperature sensor and an actual temperature of the semiconductor wafer, which causes a problem of not being able to perform a desired heat treatment quickly.

Also, in order to reduce the difference between the temperature characteristic of the heated object and the temperature characteristic of the temperature sensor, the heat receiving body needs to have a certain size. When the size of the heat receiving body increases, its own weight inevitably increases as well. Thus, due to an influence of the heat receiving body's own weight, it becomes difficult to arrange the heat receiving body and the thermocouple with high accuracy. Also, due to the heat receiving body's own weight, an attachment portion between the heat receiving body and the thermocouple receives a load, which may cause a problem of breakage or the like.

Also, a multipoint temperature sensor has a plurality of small diameter branch tubes branched from a large diameter main tube. Since thermocouples are provided at tip end portions of the plurality of branch tubes, there is a problem in which it is not easy to fix the thermocouples at accurate positions reliably.

The present invention has been made in consideration of the above respects, and an object of the present invention is to provide a temperature sensor and a heat treating apparatus supporting a temperature detecting element at an accurate position, improving a rising characteristic of a temperature, and enabling high-accuracy temperature control.

### SUMMARY OF THE INVENTION

To solve such problems, a temperature sensor according to the present invention includes a temperature detecting element detecting an ambient temperature, a heat receiving body to which the temperature detecting element is fixed and that is heated by receiving surrounding heat, a heat receiving body supporting mechanism supporting the heat receiving body at a predetermined position, and a protective tube adjusting the heat receiving body supported at the heat receiving body supporting mechanism in a predetermined direction and at a predetermined position and holding the heat receiving body therein. The heat receiving body is in a flat plate shape, the temperature detecting element is fixed to the heat receiving body, the heat receiving body supporting mechanism includes a plurality of connecting narrow tubes connected to one another and a connecting wire passing through the respective connecting narrow tubes to connect and support all the connecting narrow tubes, the respective connected connecting narrow tubes are bent halfway and are inserted in the protective tube, and the heat receiving body goes between the two parallel connecting narrow tubes of the heat receiving body supporting mechanism, is fixed, and is inserted in the protective tube to a set position to align a direction thereof with a set direction. In a heat treating apparatus, the above temperature sensor is used as a temperature sensor performing temperature measurement for temperature control.

With the invention configured as above, a rising characteristic of a temperature is improved, and high-accuracy temperature control is enabled.

### BRIEF DESCRIPTION OF THE DRAWINGS

FIG. 1 is a front cross-sectional view illustrating a temperature sensor according to a first embodiment of the present invention.

FIG. 2 is a side cross-sectional view illustrating the temperature sensor according to the first embodiment of the present invention.

FIG. 3 is a plan view illustrating the temperature sensor according to the first embodiment of the present invention.

FIG. 4 is a schematic cross-sectional view illustrating a vertical heat treating apparatus in which the temperature sensor according to the first embodiment of the present invention has been incorporated.

FIG. 5 is a front cross-sectional view illustrating a main part of a temperature sensor according to a second embodiment of the present invention.

FIG. 6 is a side cross-sectional view illustrating a main part of the temperature sensor according to the second embodiment of the present invention.

FIG. 7 is a plan view illustrating a main part of the temperature sensor according to the second embodiment of the present invention.

FIG. 8 is a front cross-sectional view illustrating a main part of a temperature sensor according to a third embodiment of the present invention.

FIG. 9 is a side cross-sectional view illustrating a main part of the temperature sensor according to the third embodiment of the present invention.

FIG. 10 is a plan view illustrating a main part of the temperature sensor according to the third embodiment of the present invention.

FIG. 11 is a front cross-sectional view illustrating a main part of a temperature sensor according to a fourth embodiment of the present invention.

FIG. 12 is a side cross-sectional view illustrating a main part of the temperature sensor according to the fourth embodiment of the present invention.

FIG. 13 is a plan view illustrating a main part of the temperature sensor according to the fourth embodiment of the present invention.

FIG. 14 is a front cross-sectional view illustrating a main part of a temperature sensor according to a fifth embodiment of the present invention.

FIG. 15 is a side cross-sectional view illustrating a main part of the temperature sensor according to the fifth embodiment of the present invention.

FIG. 16 is a plan view illustrating a main part of the temperature sensor according to the fifth embodiment of the present invention.

FIG. 17 is a plan cross-sectional view illustrating a connecting state of connecting narrow tubes of the temperature sensor according to the fifth embodiment of the present invention.

FIG. 18 is a side cross-sectional view illustrating a connecting state of the connecting narrow tubes of the temperature sensor according to the fifth embodiment of the present invention.

FIG. 19 is a front view illustrating a main part of a temperature sensor according to a sixth embodiment of the present invention.

FIG. 20 is a side view illustrating a main part of the temperature sensor according to the sixth embodiment of the present invention.

FIG. 21 is a back view illustrating a main part of the temperature sensor according to the sixth embodiment of the present invention.

### DESCRIPTION OF THE PREFERRED EMBODIMENTS

Hereinafter, a temperature sensor and a heat treating apparatus according to embodiments of the present invention will be described. The temperature sensor according to the present embodiments is improved so that a position and a direction of a heat receiving body connected at a tip end of each temperature sensor in a protective tube for a multipoint temperature sensor or the like may be adjusted and supported accurately to improve sensitivity to temperature changes. The temperature sensor according to the present invention can be applied to every temperature sensor having a configuration in which a temperature detecting element is inserted in a protective tube. The temperature sensor according to the present invention is suitable for temperature measurement or the like for temperature control of a heat treating apparatus such as a diffusion furnace in a semiconductor manufacturing apparatus. Also, the temperature sensor according to the present invention can be incorporated in various heat treating apparatuses other than the diffusion furnace.

### (A) First Embodiment

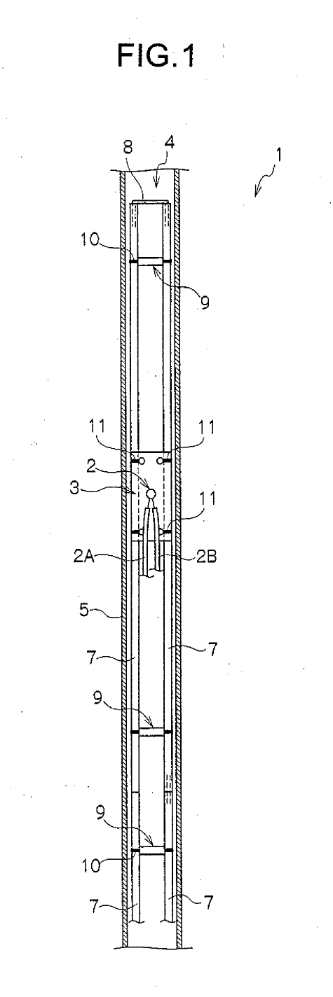

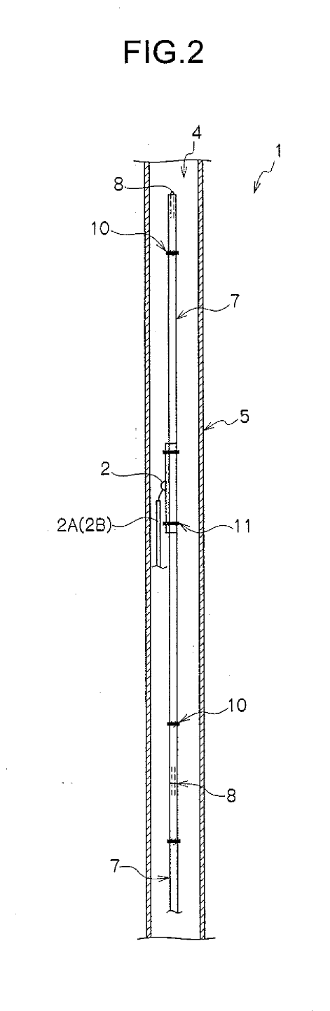

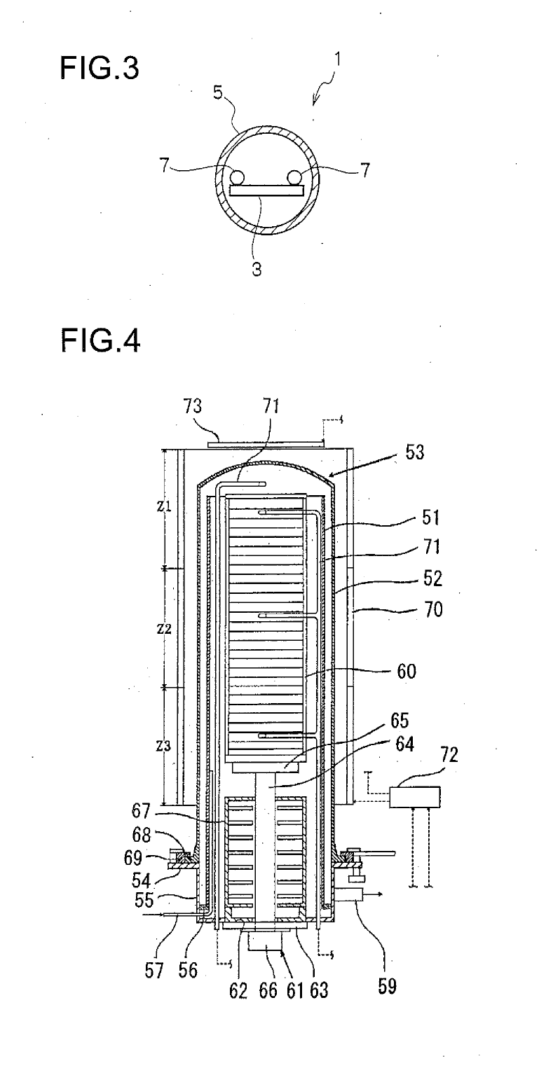

A temperature sensor 1 according to the present embodiment will be described based on FIGS. 1 to 3.

The temperature sensor 1 according to the present embodiment is configured to mainly include a temperature detecting element 2, a heat receiving body 3, a heat receiving body supporting mechanism 4, and a protective tube 5 as illustrated in the FIGS.

The temperature detecting element 2 is an element adapted to detect an ambient temperature. A thermocouple is used as the temperature detecting element 2. Another element may be used. Two cords 2A and 2B extend from the thermocouple as the temperature detecting element 2.

The heat receiving body 3 is a plate member to which the temperature detecting element 2 is fixed and that is heated by receiving surrounding heat. A plate member such as a silicon substrate, quartz, silicon carbide, and carbon can be used as the heat receiving body 3. The heat receiving body 3 is heated by receiving surrounding heat transmitted through the protective tube 5. The heat receiving body 3 is formed in a flat plate shape since it preferably occupies as large an area as possible in an inside of the protective tube 5. The temperature detecting element 2 is fixed to this heat receiving body 3. The heat receiving body 3 quickly reacts to ambient temperature changes to enable the temperature detecting element 2, which is fixed to this heat receiving body 3, to quickly react to ambient temperature changes as well along with the reaction of the heat receiving body 3.

The protective tube 5 is a tube member adapted to hold the heat receiving body 3 therein. The protective tube 5 adjusts the heat receiving body 3 supported at the heat receiving body supporting mechanism 4 in a predetermined direction and at a predetermined position and holds the heat receiving body 3 therein. A quartz tube, an SiC tube, an alumina tube, or the like can be used as the protective tube 5.

The heat receiving body supporting mechanism 4 is a mechanism adapted to support the heat receiving body 3 at a predetermined position and in a predetermined direction accurately and to attach the heat receiving body 3 to the inside of the protective tube 5. Since the temperature sensor 1 needs to detect heat changes at a measurement target position in a diffusion furnace, for example, accurately, the heat receiving body supporting mechanism 4 supports the heat receiving body 3 at the measurement target position and in a direction of the position accurately. The heat receiving body supporting mechanism 4 is formed with use of an alumina part, an alumina tube, a quartz part, a quartz tube, or the like. Specifically, the heat receiving body supporting mechanism 4 includes connecting narrow tubes 7, a connecting wire 8, supporting narrow tubes 9, and fastening wires 10.

The plurality of connecting narrow tubes 7 are connected to constitute a framework of the heat receiving body supporting mechanism 4. The connecting wire 8 passes through the respective connecting narrow tubes 7 to connect and support all the connecting narrow tubes 7. The respective connecting narrow tubes 7 connected by the connecting wire 8 are bent halfway and are inserted in the protective tube 5.

The supporting narrow tubes 9 are members adapted to keep two opposed connecting narrow tubes 7 bent halfway and arranged in parallel at a set interval. The supporting narrow tubes 9 support the two connecting narrow tubes 7 arranged in parallel at plural portions and keep them at the set interval.

The fastening wires 10 are wires adapted to keep the two parallel connecting narrow tubes 7 at the set interval and to fasten them. Each fastening wire 10 passes through the supporting narrow tube 9 and is fastened to the two connecting narrow tubes 7. The fastening wires 10 and the connecting wire 8 are made of heat-resistant wires.

The heat receiving body 3 goes between the two parallel connecting narrow tubes 7 of the heat receiving body supporting mechanism 4 and is fixed. The heat receiving body 3 is formed in a flat plate shape having an approximately equal width to the interval between the two parallel connecting narrow tubes 7. The heat receiving body 3 is fixed at both opposed end portions thereof to the respective connecting narrow tubes 7 by heat-resistant wires 11.

By doing so, the heat receiving body supporting mechanism 4 is in a bar shape and supports the heat receiving body 3 reliably. The heat receiving body supporting mechanism 4 is inserted in the protective tube 5 in this state. At this time, the heat receiving body supporting mechanism 4 is inserted in the protective tube 5 to align a direction thereof with a set direction so that the heat receiving body 3 may be fit to a set position. The heat receiving body supporting mechanism 4 is fixed at a base end portion thereof to the protective tube 5.

The temperature sensor 1 configured as above is incorporated in a heat treating apparatus. An example of the heat treating apparatus will be described based on FIG. 4. Here, a vertical heat treating apparatus adapted for a heat treatment of a semiconductor wafer is taken as an example. This vertical heat treating apparatus includes a treating container (process tube) 53 having a double-tube structure consisting of a straight-tube-like inner tube 51 arranged to extend in a height direction (up-down direction in FIG. 4) and opened at an upper end thereof and an outer tube 52 arranged concentrically around the inner tube 51 with a predetermined space in-between and closed at an upper end thereof, and a lower space of the treating container 53 is a loading area L in which transfer and the like of a semiconductor wafer as a treated body to an after-mentioned wafer boat 60 as a treated body holding tool are performed. The inner tube 51 and the outer tube 52 are made of a material excellent in heat resistance and corrosion resistance such as high-purity quartz glass.

A lower end portion of the outer tube 52 in this treating container 53 is provided with a short cylindrical manifold 55 having a flange portion 54 at an upper end thereof. To the flange portion 54 is connected by a flange holder 69 a lower end flange portion 68 provided at a lower end portion of the outer tube 52 via a sealing means (not shown) such as an O ring to bring a state in which the outer tube 52 of the treating container 53 is fixed. The inner tube 51 in the treating container 53 extends downward from a lower end surface of the outer tube 52 and is supported by an annular inner tube supporting portion 56 provided on an inner surface of the manifold 55 in a state of being inserted in the manifold 55.

On a vertical cross-section of the treating container 53 of this vertical heat treating apparatus, one sidewall of the manifold 55 is provided with a gas supply pipe 57 adapted to introduce treating gas and inert gas in the treating container 53. To this gas supply pipe 57 is connected a not illustrated gas supply source. Also, the other sidewall of the manifold 55 is provided with an exhaust portion 59 adapted to exhaust gas in the treating container 53. To this exhaust portion 59 is connected an exhaust mechanism (not shown) having a vacuum pump and a pressure control mechanism, for example, to cause the inside of the treating container 53 to be controlled at predetermined pressure.

On a lower side of the treating container 53 is provided an elevating mechanism 61 driven in an up-down direction to carry the wafer boat 60 as a treated body holding tool in and out of the treating container 53, and the elevating mechanism 61 has a circular-plate-shaped lid 63 adapted to open and close a lower end opening 62 of the treating container 53. The wafer boat 60 is made of high-purity quartz glass, for example. In the wafer boat 60, a plurality of semiconductor wafers such as 100 to 150 semiconductor wafers are mounted in parallel on multiple stages at predetermined pitches vertically such as 5.2 to 20.8 mm.

The lid 63 in the elevating mechanism 61 is provided with a columnar supporting member 64 extending upward in parallel with the treating container 53 in a state of penetrating the lid 63. This supporting member 64 is provided integrally with a circular-plate-shaped boat support 65 on which the wafer boat 60 is to be mounted and is connected to a rotary driving means 66 provided at a lower portion of the lid 63. Also, at an upper portion of the lid 63 is provided a heat-retention cylinder 67 made of quartz, for example, in a state in which the supporting member 64 is inserted therein.

On an outside of the treating container 53 is provided a cylindrical heater 70 as a heating means adapted to heat the semiconductor wafers housed in the treating container 53 at a predetermined treating temperature in a state of surrounding a circumference of the treating container 53. The cylindrical heater 70 is provided with a cylindrical heat insulating material (not shown) on an inner surface of which a linear resistance heating element is arranged in a spiral manner or in a serpentine manner. The resistance heating element is connected to a control unit 72 adapted to control magnitude of electric power to be supplied so that the semiconductor wafers may be in a state of a preset temperature based on temperature data of the semiconductor wafers detected by a temperature detector 71.

By dividing the treating container 53 into a plurality of heating zones such as three heating zones Z1 to Z3 in the illustrated example in a height direction, this cylindrical heater 70 is in a state of enabling independent temperature control for the respective heating zones, that is, in a state of enabling zone control.

On an upper side of the treating container 53 is provided a sheet-like heater 73 arranged in parallel with an upper end surface of the cylindrical heater 70 in a state of being opposed to the wafer boat 60 in the treating container 53. By doing so, heat dissipation from an upper side of the treating container 53 is prevented efficiently, and the semiconductor wafers can be subjected to a heat treatment with high in-plane uniformity. The sheet-like heater 73 is made by providing a linear resistance heating element on a plate-like base material, for example, and this resistance heating element is connected to the control unit 72.

In the vertical heat treating apparatus configured as above, the control unit 72 controls the cylindrical heater 70, the sheet-like heater 73, and the like to make the wafer boat 60 subjected to a heat treatment.

In this vertical heat treating apparatus, the temperature sensor 1 according to the present embodiment is arranged as the temperature detector 71.

In this temperature sensor 1, since it is possible to figure out accurately at which position in the protective tube 5 and in which direction the heat receiving body 3 supporting the temperature detecting element 2 is attached, the heat receiving body 3 can be attached accurately so that the temperature detecting element 2 may be located at a measurement target position in a diffusion furnace or the like.

As a result, the temperature detecting element 2 of the heat receiving body 3 located at an accurate position and in an accurate direction to the measurement target position follows a temperature of the measurement target position quickly.

Consequently, the temperature sensor 1 can follow temperature changes at the measurement target position quickly, improve a rising characteristic of a temperature, and perform high-accuracy temperature control. In addition, the temperature sensor 1 according to the present embodiment can achieve this easily and reliably.

Also, even when a size of the heat receiving body 3 is increased to some extent, and its own weight is increased in order to reduce a difference between a temperature characteristic of a heated object as a treating target and a temperature characteristic of the temperature sensor 1, the heat receiving body 3 is supported at a predetermined position and in a predetermined direction accurately and reliably by the heat receiving body supporting mechanism 4. Thus, the temperature detecting element 2 and the heat receiving body 3 can be arranged with high accuracy, and temperature measurement can be performed with high accuracy.

### (B) Second Embodiment

Next, a second embodiment of the present invention will be described.

A temperature sensor 14 according to the present embodiment is characterized by including a heat receiving body supporting joint. The other components are similar to those of the first embodiment.

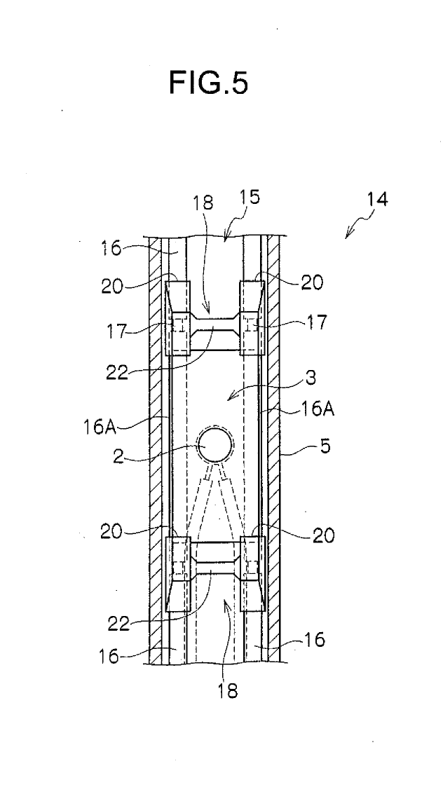

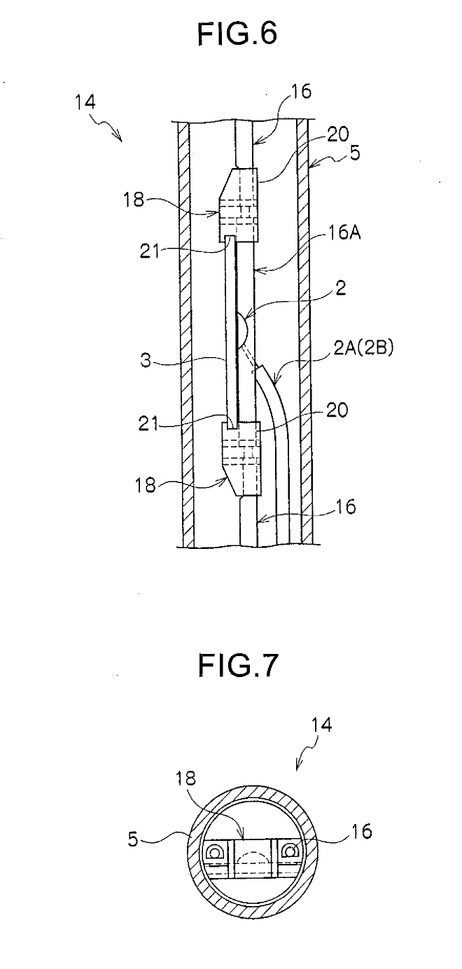

A heat receiving body supporting mechanism 15 according to the present embodiment includes connecting narrow tubes 16, a connecting wire 17, and heat receiving body supporting joints 18 as illustrated in FIGS. 5 to 7.

The connecting narrow tubes 16 and the connecting wire 17 (the connecting wire 17 illustrated in FIG. 5 in a state of passing through an inside of a center of a hole of a joint portion 20 in which the connecting narrow tube 16 is to be fitted) are similar to the connecting narrow tubes 7 and the connecting wire 8 described above. The length of the connecting narrow tube 16 according to the present embodiment is set in accordance with a position in which one wishes to support the heat receiving body supporting joint 18. Also, among the connecting narrow tubes 16, a connecting narrow tube 16A located between the two heat receiving body supporting joints 18 is set to have an approximately equal length to that of the heat receiving body 3.

The heat receiving body 3 has a structure in which both ends thereof in a longitudinal direction are supported as the two heat receiving body supporting joints 18 are fitted therein and is thus made of a flat-surface-like plate member. The temperature detecting element 2 is attached to this heat receiving body 3.

The heat receiving body supporting joints 18 are members adapted to insert the two connecting narrow tubes 16 therein and support them and to support the heat receiving body 3 from both sides in a longitudinal direction of the heat receiving body 3. Each heat receiving body supporting joint 18 includes the joint portions 20 adapted to insert respective end portions of the two connecting narrow tubes 16 therein and support the respective end portions halfway through the plurality of connecting narrow tubes 16 and supporting recess portions 21 adapted to be fitted to an end portion in a longitudinal direction of the heat receiving body 3 and support the end portion. A hole portion of the joint portion 20 is formed in a D shape (semicircular shape). To correspond to this, the end portion of the connecting narrow tube 16 is also formed in a D shape. This prevents the connecting narrow tube 16 from turning and twisting entirely. This D-shaped hole and the like can be used similarly in other embodiments.

Two joint portions 20 and supporting recess portions 21 are provided to correspond to the two connecting narrow tubes 16. The respective joint portions 20 and the respective supporting recess portions 21 are connected integrally by a connecting rod 22.

Two heat receiving body supporting joints 18 are provided to support the heat receiving body 3 from both sides in a longitudinal direction of the heat receiving body 3. The two heat receiving body supporting joints 18 are installed to be opposed to each other in a state of inserting respective end portions of the two connecting narrow tubes 16 in the joint portions 20 and supporting the respective end portions halfway through the plurality of connecting narrow tubes 16. By doing so, the two heat receiving body supporting joints 18 support the heat receiving body 3 from both sides in a longitudinal direction of the heat receiving body 3. Specifically, the respective heat receiving body supporting joints 18 leave a set distance by the short connecting narrow tube 16A and are supported. The four supporting recess portions 21 of the respective heat receiving body supporting joints 18 are fitted to four edges of the heat receiving body 3, respectively, to support the heat receiving body 3. The long connecting narrow tubes 16 on both sides of the respective heat receiving body supporting joints 18 are adjusted to have set lengths, and the temperature sensor 14 is supported at a predetermined position.

The heat receiving body supporting mechanism 15 configured as above is inserted in the protective tube 5 in this state. At this time, the heat receiving body supporting mechanism 15 is inserted in the protective tube 5 to align a direction thereof with a set direction so that the heat receiving body 3 may be fit to a set position. The heat receiving body supporting mechanism 15 is fixed at a base end portion thereof to the protective tube 5.

The temperature sensor 14 configured as above can exert similar effects to those of the first embodiment.

### (C) Third Embodiment

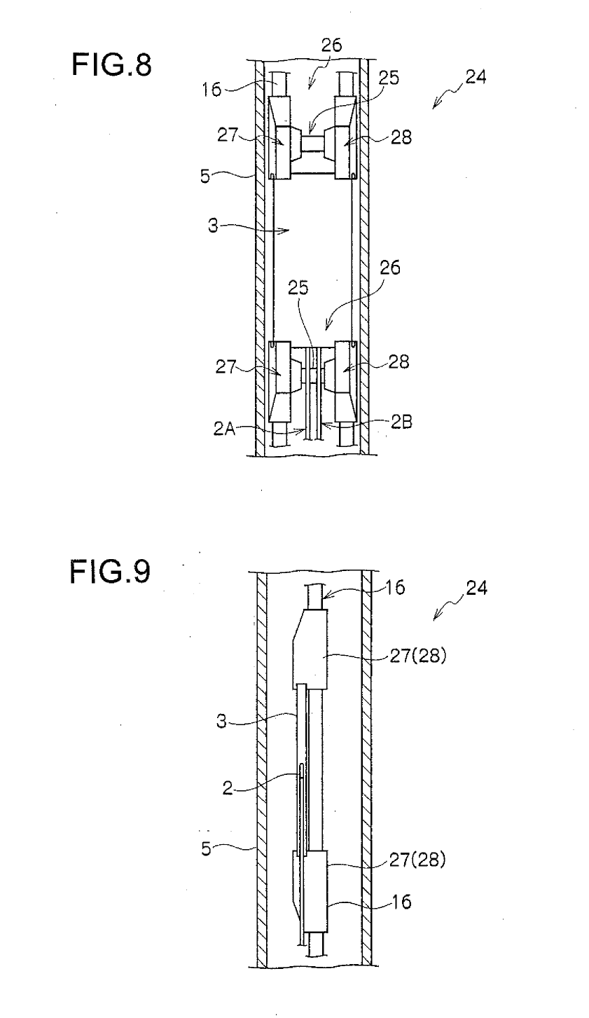

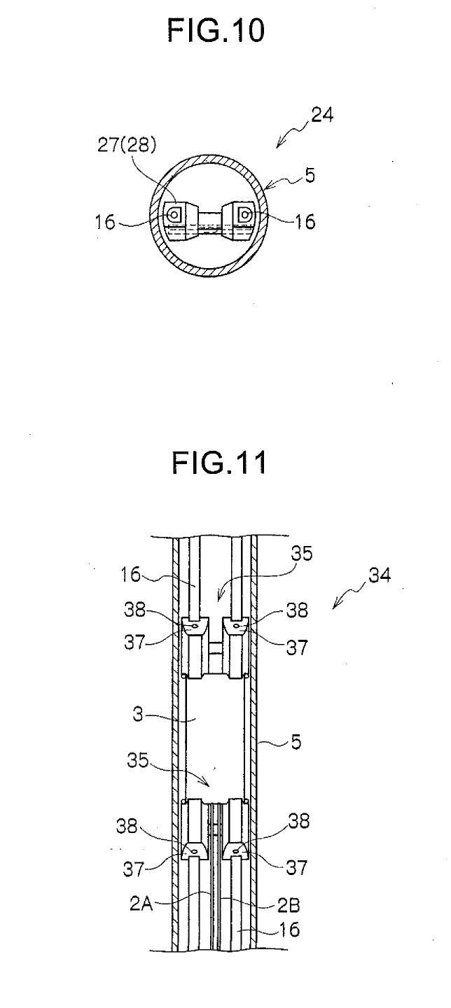

Next, a third embodiment of the present invention will be described based on FIGS. 8 to 10.

A temperature sensor 24 according to the present embodiment is characterized by improving the connecting rod 22 in the second embodiment. The other components are similar to those of the second embodiment.

A connecting rod 25 according to the present embodiment is configured as a different member from the respective joint portions 20 and supporting recess portions 21.

Accordingly, a heat receiving body supporting joint 26 includes a first piece 27 consisting of one joint portion 20 and one supporting recess portion 21, a second piece 28 consisting of the other joint portion 20 and the other supporting recess portion 21, and the connecting rod 25 having D-shaped end portions that are fitted in D-shaped hole portions provided in the first piece 27 and the second piece 28, respectively.

As for the connecting rod 25, ones having plural lengths are set. Specifically, connecting rods 25 having plural lengths are used to correspond to a plurality of heat receiving bodies 3 having different dimensions, respectively.

The temperature detecting element 2 is buried in an inside of the heat receiving body 3. The other components are similar to those of the second embodiment.

The temperature sensor 24 configured as above can exert similar effects to those of the first embodiment and can deal with heat receiving bodies 3 having various dimensions.

### (D) Fourth Embodiment

Next, a fourth embodiment of the present invention will be described.

A temperature sensor 34 according to the present embodiment is characterized by improving the heat receiving body supporting joint 18 in the second embodiment. The other components are similar to those of the second embodiment.

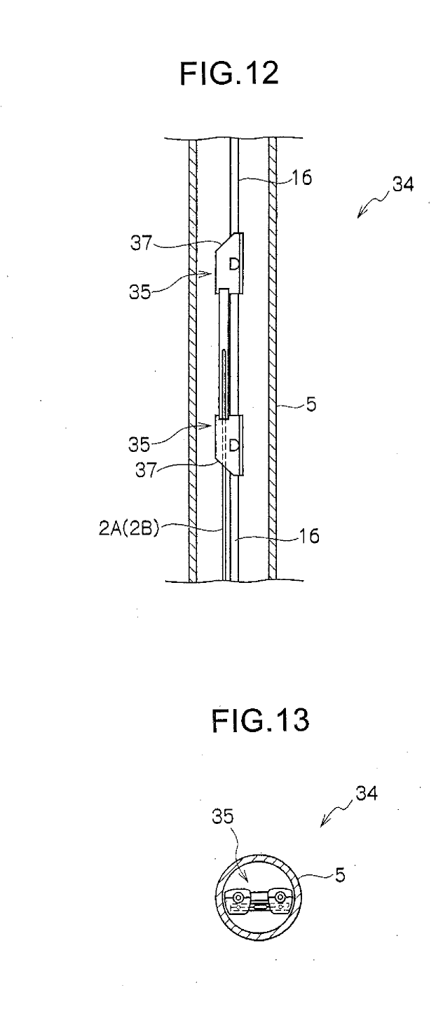

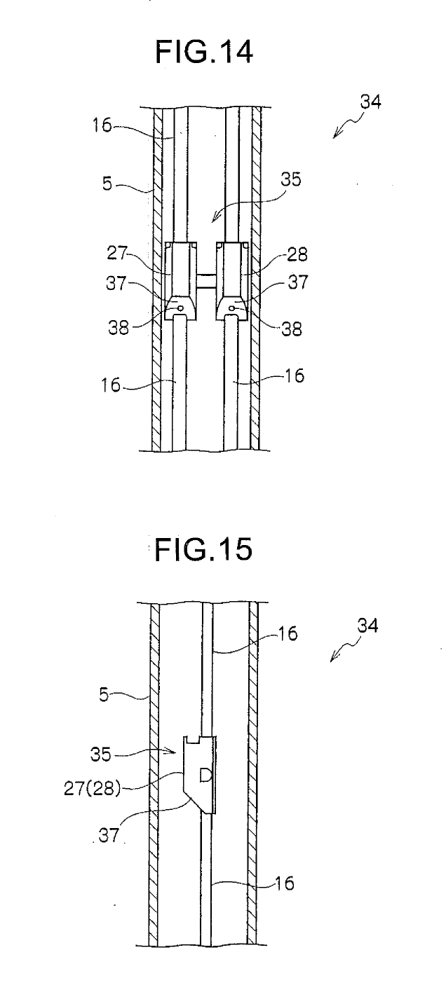

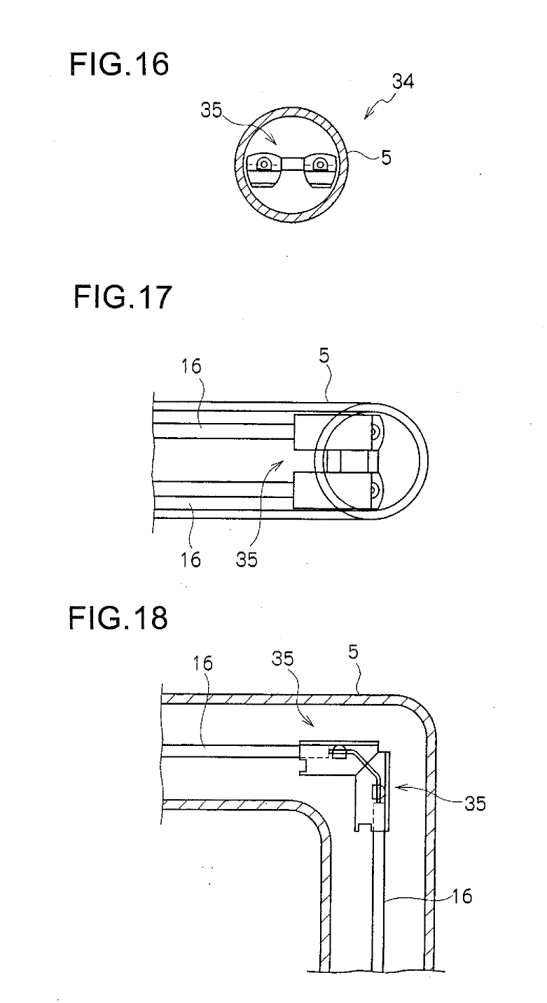

A heat receiving body supporting joint 35 according to the present embodiment functions similarly to the heat receiving body supporting joint 18 in the second embodiment as illustrated in FIGS. 11 to 13 and also functions as an intermediate joint as illustrated in FIGS. 14 to 18.

The heat receiving body supporting joint 35 functions as a joint for relay connecting the connecting narrow tubes 16 as illustrated in FIGS. 14 to 16. The heat receiving body supporting joint in other embodiments also has this function as a joint for relay.

The heat receiving body supporting joint 35 also functions to connect the connecting narrow tubes 16 by bending the connecting narrow tubes 16 by a predetermined angle. The heat receiving body supporting joint 35 includes an inclined surface 37 and a wire hole 38 that makes the connecting wire 17 pass therethrough as illustrated in FIGS. 14 to 18. The inclined surface 37 is a surface adapted to bend the connecting narrow tube 16 by a predetermined angle and connect the connecting narrow tube 16. Respective inclined surfaces 37 of two heat receiving body supporting joints 35 contact each other and make the connecting wire 17 pass through respective wire holes 38 to connect the connecting narrow tubes 16 with a predetermined angle (90 degrees in the present embodiment).

### (E) Fifth Embodiment

Next, a fifth embodiment of the present invention will be described.

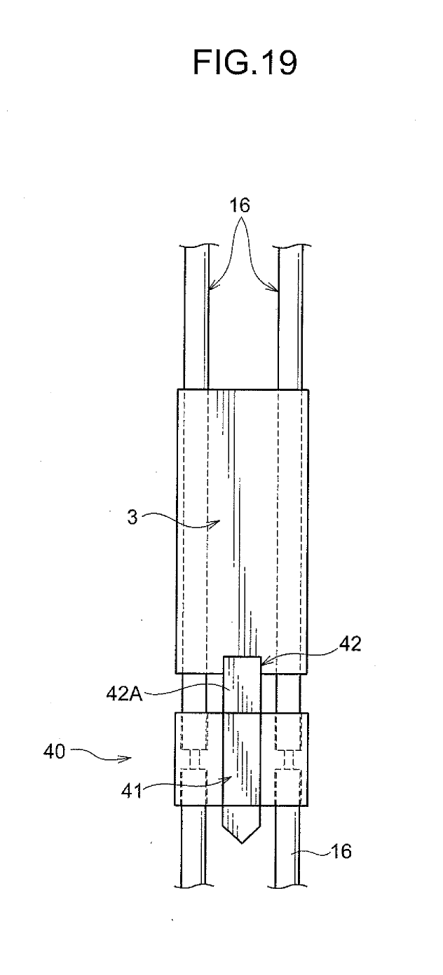

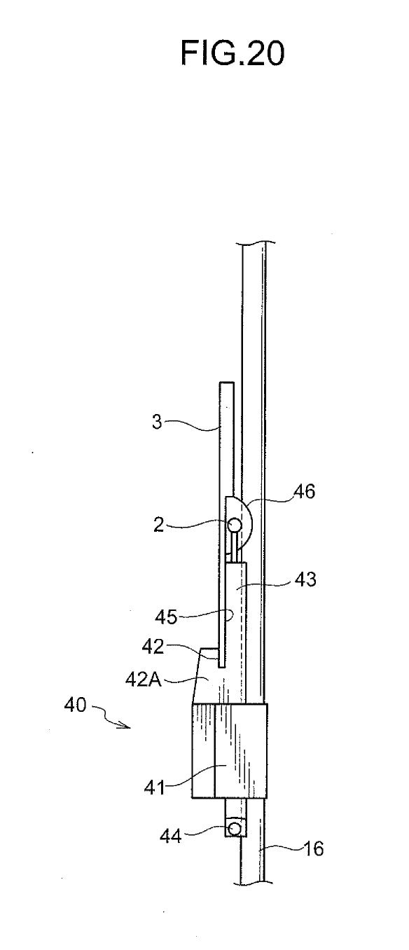

In the present embodiment, a heat receiving body supporting joint 41 of a heat receiving body supporting mechanism 40 is improved. Specifically, as illustrated in FIGS. 19 to 21, the heat receiving body supporting joint 41 supports the heat receiving body 3 in a cantilevered manner to connect the respective connecting narrow tubes 16.

The heat receiving body supporting mechanism 40 includes a joint portion 41 adapted to insert respective end portions of the two connecting narrow tubes 16 therein and support the respective end portions halfway through the plurality of connecting narrow tubes 16, a supporting recess 42 adapted to be fitted to an end portion of the heat receiving body 3 and support the heat receiving body 3 in a cantilevered manner, a supporting piece 43 constituting one surface of this supporting recess 42 and extending this surface to support one side surface of the heat receiving body 3, and cord holes 44 provided in this supporting piece 43 and the joint portion 41 to make the cords 2A and 2B of the temperature detecting element 2 pass therethrough.

The joint portion 41 is similar to the aforementioned joint portion 20. The supporting recess 42 is a recess adapted to support the heat receiving body 3 accurately. The supporting recess 42 is constituted by a recess having a width of an approximately equal length to that of a thickness of one end portion of the heat receiving body 3.

The supporting recess 42 is provided on a tip end side of a thick-plate-like member 42A extending in a longitudinal direction of the protective tube 5 from the heat receiving body supporting joint 41. The supporting recess 42 is provided at an accurate position on the tip end side of the member 42A. By doing so, one end portion of the heat receiving body 3 is fitted in the supporting recess 42 and is supported by the supporting recess 42, and by applying tension to the cords 2A and 2B, the heat receiving body 3 is reliably fitted in the supporting recess 42 and is accurately positioned without positional displacement.

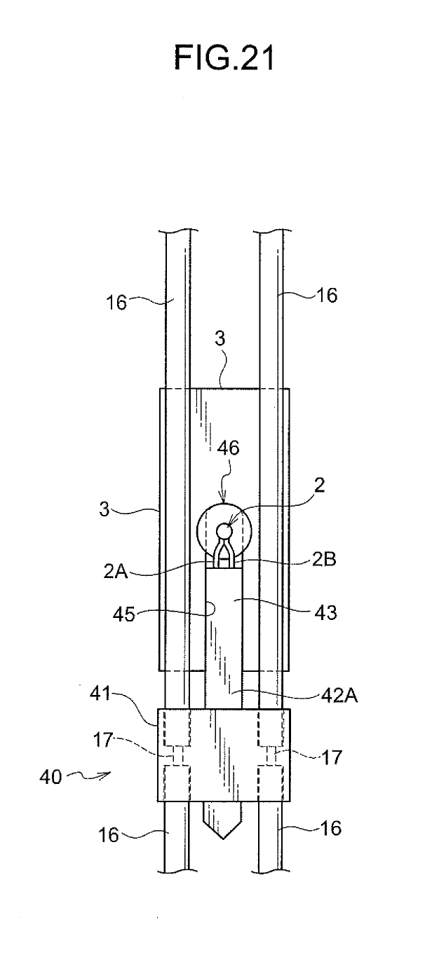

The supporting piece 43 supports one side surface of the heat receiving body 3, and the one side surface of the heat receiving body 3 is provided with a fitting recess 45 in which the supporting piece 43 is to be fitted. The fitting recess 45 is formed to have an approximately equal width to a width of the supporting piece 43. By doing so, the fitting recess 45 supports the supporting piece 43 so as not to shift in a right-left direction in FIGS. 19 and 21. At a tip end of the supporting piece 43, the temperature detecting element 2 is fixed to the heat receiving body 3 by adhesive 46 or the like. This prevents the heat receiving body 3 from shifting in front-back, right-left, and up-down directions of the supporting piece 43. Additionally, by the cords 2A and 2B which are made to pass through the cord holes 44 and to which tension is applied, the heat receiving body 3 is supported by the supporting recess 42 and the supporting piece 43 reliably without shifting.

The cord holes 44 are holes adapted to arrange the cords 2A and 2B from the temperature detecting element 2 to a base end side. The cord holes 44 are provided to penetrate the aforementioned member 42A and the supporting piece 43. By the cords 2A and 2B made to pass through these cord holes 44, the heat receiving body 3 is adapted to be pulled to a side of the supporting recess 42 and the supporting piece 43 and be supported.

By this configuration, similar effects to those of the first embodiment can be exerted, and a supporting structure of the supporting piece 43 is simplified. Heat receiving bodies 3 having various dimensions can be supported easily and reliably at an accurate position regardless of the differences of the dimensions of the heat receiving bodies 3.

It is to be noted that, although a case in which the temperature detecting element 2 is mounted in a protective tube of a multipoint temperature sensor has been taken as an example in the above embodiments, the present invention can be applied to a temperature sensor other than the multipoint temperature sensor as long as the temperature sensor includes a protective tube.

The present invention is not limited to the above respective embodiments as they are but can be embodied in a practical phase by altering the respective components without departing from the spirit and scope thereof. Also, various inventions can be formed by appropriate combination of plural components disclosed in the above respective embodiments. For example, several components may be deleted from all the components shown in an embodiment. Also, components in different embodiments may be combined as needed.

1. A temperature sensor comprising:
a temperature detecting element detecting an ambient temperature;
a heat receiving body to which the temperature detecting element is fixed and that is heated by receiving surrounding heat;
a heat receiving body supporting mechanism supporting the heat receiving body at a predetermined position; and
a protective tube adjusting the heat receiving body supported at the heat receiving body supporting mechanism in a predetermined direction and at a predetermined position and holding the heat receiving body therein,
wherein the heat receiving body is in a flat plate shape,
wherein the temperature detecting element is fixed to the heat receiving body,
wherein the heat receiving body supporting mechanism includes a plurality of connecting narrow tubes connected to one another and a connecting wire passing through the respective connecting narrow tubes to connect and support all the connecting narrow tubes,
wherein the respective connected connecting narrow tubes are bent halfway and are inserted in the protective tube, and
wherein the heat receiving body goes between the two parallel connecting narrow tubes of the heat receiving body supporting mechanism, is fixed, and is inserted in the protective tube to a set position to align a direction thereof with a set direction.

2. The temperature sensor according to claim 1, wherein the heat receiving body supporting mechanism further includes a supporting narrow tube supporting the two parallel connecting narrow tubes at plural portions and keeping the two parallel connecting narrow tubes at a set interval and a fastening wire passing through the supporting narrow tube to keep the two parallel connecting narrow tubes at the set interval and to fasten the two parallel connecting narrow tubes.

3. The temperature sensor according to claim 1, wherein the heat receiving body supporting mechanism further includes two heat receiving body supporting joints installed to be opposed to each other in a state of inserting respective end portions of the two connecting narrow tubes therein and supporting the respective end portions halfway through the plurality of connecting narrow tubes and supporting the heat receiving body from both sides of the heat receiving body.

4. The temperature sensor according to claim 1, wherein the heat receiving body supporting mechanism further includes a heat receiving body supporting joint including a joint portion inserting respective end portions of the two connecting narrow tubes therein and supporting the respective end portions halfway through the plurality of connecting narrow tubes, a supporting recess fitted to an end portion of the heat receiving body and supporting the heat receiving body in a cantilevered manner, a supporting piece constituting one surface of the supporting recess and extending this surface to support one side surface of the heat receiving body, and a cord hole provided in the supporting piece to make a cord of the temperature detecting element pass therethrough.

5. The temperature sensor according to claim 1, further comprising:
one or more intermediate joints provided halfway through the plurality of connecting narrow tubes and bending the connecting narrow tubes by a predetermined angle to arrange the connecting narrow tubes,
wherein the intermediate joint includes an inclined surface and a wire hole provided in the inclined surface and making the connecting wire pass therethrough, and
wherein the two intermediate joints make the connecting wire pass through the wire holes with the inclined surfaces thereof contacting each other to connect the connecting narrow tubes with a predetermined angle.

6. A heat treating apparatus performing a heat treatment by controlling a temperature of a target, wherein the temperature sensor according to claim 5 is used as a temperature sensor performing temperature measurement for control of the temperature.

7. A heat treating apparatus performing a heat treatment by controlling a temperature of a target, wherein the temperature sensor according to claim 4 is used as a temperature sensor performing temperature measurement for control of the temperature.

8. A heat treating apparatus performing a heat treatment by controlling a temperature of a target, wherein the temperature sensor according to claim 3 is used as a temperature sensor performing temperature measurement for control of the temperature.

9. A heat treating apparatus performing a heat treatment by controlling a temperature of a target, wherein the temperature sensor according to claim 2 is used as a temperature sensor performing temperature measurement for control of the temperature.

10. A heat treating apparatus performing a heat treatment by controlling a temperature of a target, wherein the temperature sensor according to claim 1 is used as a temperature sensor performing temperature measurement for control of the temperature.
